(19) United States
(12) Patent Application Publication
(10) Pub. No.: US 2019/0134942 A1
(43) Pub. Date: May 9, 2019

(54) ADHESIVE PROTECTION ELEMENT

(71) Applicant: Giovanni SOMASCHINI, Seregno (IT)

(72) Inventor: Giovanni SOMASCHINI, Seregno (IT)

(21) Appl. No.: 16/175,114

(22) Filed: Oct. 30, 2018

(30) Foreign Application Priority Data
Nov. 7, 2017 (IT) 102017000126278

(51) Int. Cl. B32B 3/30; B32B 7/12; B32B 27/08; B32B 27/30

(52) U.S. Cl. CPC B32B 3/30; B32B 7/12; B32B 27/08; B62J 23/00; B32B 2307/536; B32B 2605/00; B32B 27/304

(57) ABSTRACT

An adhesive protection element includes a layer of PVC underneath which a layer of insulating primer is applied. A layer of transfer adhesive is applied to the layer of primer.

### CROSS-REFERENCE TO RELATED APPLICATIONS

This application is related to and claims the benefit of Italian Patent Application No. 102017000126278, filed on Nov. 7, 2017, the contents of which are herein incorporated by reference in their entirety.

### TECHNICAL FIELD

The present disclosure relates to an adhesive protection element. More specifically, the disclosure relates to an adhesive protection element, which is adapted in particular for use as an adhesive protection element for fuel tanks on motorcycles and the like. The disclosure can also be used for other purposes, for example as protection for corner edges and the like.

### BACKGROUND

As is known, in the field of adhesive protection elements for motorcycles, it is common to use protection elements that are adapted to be applied to the fuel tank so as to enable the motorcyclist to place his or her knees on the tank and obtain a grip on the protection element. This protects the tank from the friction applied against it, and it also enables the motorcyclist to effectively manage his or her motion by virtue of the traction that his or her knees receive in contact with the protection element.

Currently known protection elements are made of vulcanized rubber, but vulcanization is affected by a number of limitations. In the first place in fact it is necessary to carry out a vulcanization of the rubber, the resulting protection is not particularly soft and it is a complex matter to provide a mold even just to produce a two-color protection element.

Furthermore, conventional protection elements are adhesive and therefore on the one hand they can be easily applied to the fuel tank of a motorcycle, but on the other hand their removal, for example in order to be repositioned, may be difficult in that the adhesive tends to remain attached to the surface to which the protection element was applied.

### SUMMARY

The present disclosure provides an adhesive protection element that allows both to provide an adequate grip so as to ensure greater sensitivity in riding when the protection element is applied to a motorcycle, and to allow the repositioning of the protection element without the adhesive remaining attached to the surface on which the protection element had been applied.

Within this aim, the present disclosure provides an adhesive protection element that is made of a material that is adapted to be shaped by way of a mold.

The present disclosure also provides an adhesive protection element that has high resistance to heat.

The present disclosure further provides a protection element that can be easily provided with multiple colors.

The present disclosure provides an adhesive protection element that is highly reliable, easily and practically implemented and at low cost.

This aim and these and other advantages which will become better apparent hereinafter are achieved by providing an adhesive protection element comprising a layer of PVC underneath which a layer of insulating primer is applied, a layer of transfer adhesive being applied to said layer of primer.

### BRIEF DESCRIPTION OF THE DRAWINGS

Further characteristics and advantages of the disclosure will become better apparent from the detailed description of a preferred, but not exclusive, embodiment of the protection element according to the disclosure, which is illustrated by way of non-limiting example in the accompanying drawings wherein:

FIG. 1 is a perspective view of the adhesive protection element according to the disclosure;

FIG. 2 is a plan view of the protection element according to the disclosure; and

FIG. 3 is a cross-sectional view of the protection element in FIGS. 1 and 2.

### DETAILED DESCRIPTION OF THE DRAWINGS

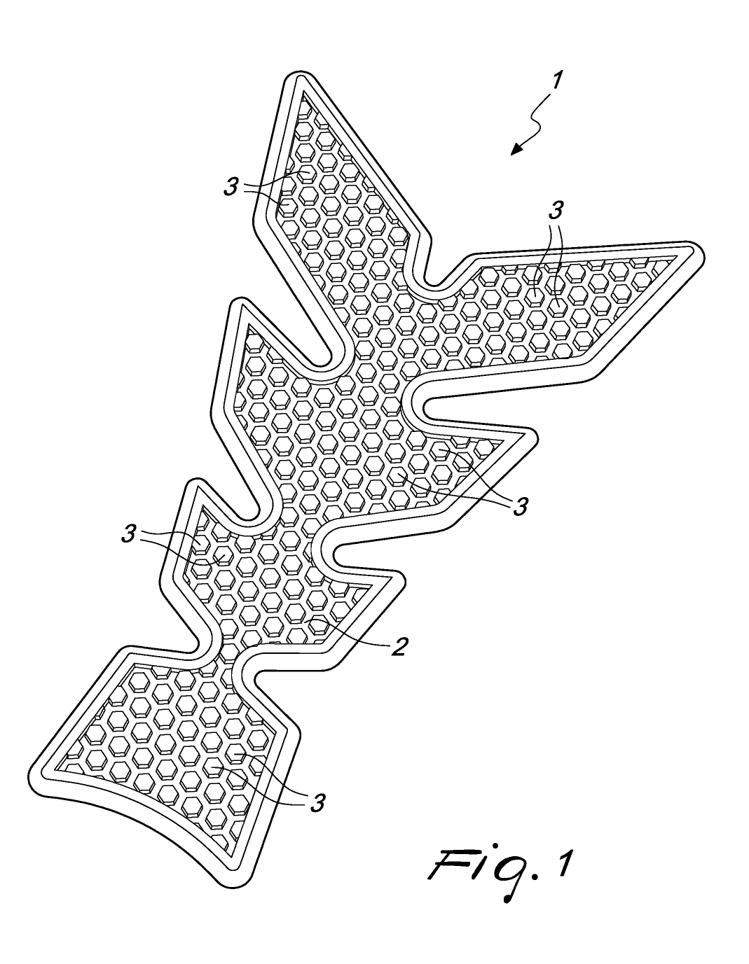

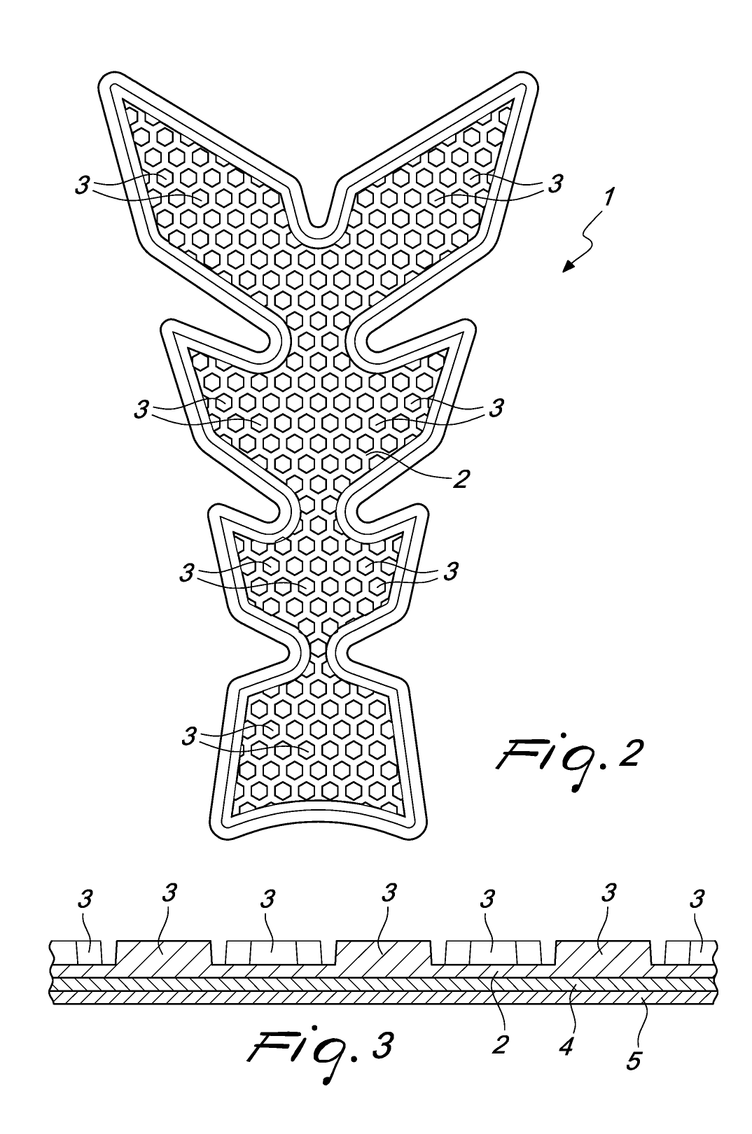

With reference to FIGS. 1-3, the protection element according to the disclosure, generally designated by the reference numeral 1, comprises a layer 2 of PVC on whose external surface, which is adapted to come into contact with the knees of the motorcyclist, for example if the protection element 1 is applied to a motorcycle, a plurality of relief elements 3 are defined, for example hexagonal, which enable the clothing, be it a leather bodysuit or conventional clothing for daily use, to obtain a grip inside the spaces that delimit each hexagon, thus providing, during the ride, a form of grip to the user's legs.

The grip conferred by the hexagons 3 enables the sports practitioner to obtain greater ride sensitivity in sport, and to always give the user a sense of safety.

The PVC with which the upper surface of the protection element is made advantageously has an established Shore hardness of 25-50.

The above value enables the hexagons 3 to move, allowing the clothing to penetrate, but without crumbling with extreme use.

The protection element according to the disclosure has, at the lower face of the PVC element 2, a layer 4 of insulating primer underneath which there is a layer 5 of transfer adhesive.

With the use of this type of adhesive, the article remains softer and more malleable, thus allowing a perfect application and shape-adaptation on motorcycle fuel tanks where the protection element can also be applied with prominent fold lines, without the risk of its becoming unglued later on.

The used PVC has a composition with a neutral base, pigment, and 15/30% plasticizer.

The production method of the protection element according to the disclosure entails preparing a female mold part, cold-pouring liquid PVC/plastisol into it, and subsequently heating it in an oven at about 200/250° C.

After the step of extraction from the mold, an insulating primer is spread on the rear part of the layer of PVC.

At this point negative templates are provided, into which the solidified PVC casting is inserted in order to proceed with the subsequent step of adhesive application. The adhesive is applied by way of a cold laminator.

In practice it has been found that the protection element according to the disclosure fully achieves the intended aim and objects, as it enables a high level of grip for the motorcyclist, while at the same time it is possible to remove it and reposition it without the adhesive remaining attached to the surface to which the protection element was applied, and furthermore the relief elements of the surface have such a hardness that allows such relief elements to move to allow the clothing worn by the motorcyclist to penetrate between them, in order to increase the grip.

The adhesive protection element thus provided is susceptible of numerous modifications and variations.

Moreover, all the details may be substituted by other, technically equivalent elements.

In practice the materials employed, and the contingent shapes and dimensions, may be any according to requirements and to the state of the art.

1. An adhesive protection element, comprising a layer of PVC underneath which a layer of insulating primer is applied, a layer of transfer adhesive being applied to said layer of insulating primer.

2. The adhesive protection element according to claim 1, wherein said layer of PVC has a Shore hardness of 25-50.

3. The adhesive protection element according to claim 1, wherein the external surface of said layer of PVC, which is opposite to the surface of said layer of PVC to which said layer of insulating primer is applied, is provided with protruding elements.

4. The adhesive protection element according to claim 3, wherein said protruding elements are hexagonal.

5. The adhesive protection element according to claim 1, wherein the PVC of said PVC layer comprises an inert base, pigment, and plasticizer.

6. A method for providing an adhesive protection element, the method including the following steps:
preparing a female mold part and cold-pouring PVC and plasticizer into the female mold part;
heating in an oven;
extracting from the mold;
spreading a layer of insulating primer on one face of the PVC article obtained; and
coupling, by way of a cold laminator, a layer of transfer adhesive to said layer of insulating primer.

7. The method according to claim 6, wherein said plasticizer is used in a quantity of 15%-30%.
